(19) United States
(12) Patent Application Publication
(10) Pub. No.: US 2018/0101067 A1
(43) Pub. Date: Apr. 12, 2018

(54) LIQUID CRYSTAL DISPLAY DEVICE

(71) Applicant: Shenzhen China Star Optoelectronics Technology Co., Ltd., Shenzhen City (CN)

(72) Inventors: Lixuan Chen, Shenzhen City (CN); Yungjui Lee, Shenzhen City (CN)

(21) Appl. No.: 15/109,126

(22) PCT Filed: Jun. 15, 2016
(86) PCT No.: PCT/CN2016/085776

§ 371 Date: Jun. 30, 2016

(30) Foreign Application Priority Data
May 9, 2016 (CN) 201610303829.8

(51) Int. Cl. G02F 1/1335; G02F 1/1368

(52) U.S. Cl. CPC G02F 1/133615; G02F 1/1368; G02F 2001/136222; G02F 1/133528; G02F 1/133514

(57) ABSTRACT

The present invention provides an LCD device, which includes a lower substrate (10) and an upper substrate (20) opposite to each other, a liquid crystal layer (30) interposed between the lower substrate (10) and the upper substrate (20), and a side-edge backlight source (40) disposed at one lateral side of the lower substrate (10). The liquid crystal layer (30) includes a self-aligning liquid crystal material that includes a material having an alignment function. A PI-free manufacturing process is utilized and no PI alignment film is provided on the upper and lower substrates. The polarization layer of the lower substrate is of an internally built arrangement with the backing base plate of the lower substrate serving as a light guide plate of a side-edge backlight source so that there is no need to further include an additional light guide plate and an ultrathin modular structure with optimized displaying performance is provided

### BACKGROUND OF THE INVENTION

### 1. Field of the Invention

The present invention relates to the field of liquid crystal display technology, and in particular to a liquid crystal display (LCD) device.

### 2. The Related Arts

Liquid crystal displays (LCDs) have a variety of advantages, such as thin device body, low power consumption, and being free of radiation, and thus have wide applications. Most of the LCDs that are currently available in the market are backlighting LCDs, which comprise a liquid crystal display panel and a backlight module. The liquid crystal display panel is generally made up of a color filter (CF) substrate, a thin-film transistor (TFT) array substrate, and a liquid crystal (LC) layer interposed between the CF substrate and the TFT array substrate, and sealant.

The working principle of the liquid crystal display panel is that liquid crystal molecules are positioned between two parallel glass substrates and electricity is applied to the glass substrates to control the orientation of the liquid crystal molecules and thus varying polarization state of light from the backlight module. Polarization plates are arranged on opposite sides of the liquid crystal display panel to determine passage or blocking of the light therethrough thereby achieving control of the amount of light transmitting therethrough. With a color resist layer filtering and absorbing light that transmits through the liquid crystal layer, light emitting from each of pixels is composed of three primary colors, red (R), green (G), and blue (B) and different ones of the pixels may emit different colors of light. Full color displaying may thus be achieved through spatial color mixture. Obviously, polarized light and three primary colors of R, G, and B are two vital factors for displaying.

Heretofore, polarization plates that are commonly used are of two types, namely iodine series and dye series, of which the manufacture is that a polymeric film, such as polyvinyl alcohol (PVA), is dipped in a solution containing polyvalent iodine ions or polarizing dyes and PVA polymer is stretched un-axially. PVA molecules, when stretched by an external force, will align in a specific direction to allow the iodine ions or dye molecules attached on the PVA molecules to line up in the same direction as that of the PVA molecules. The thin and elongate iodine ions or dye molecules, after the stretching, will absorb light that is polarized in a direction substantially parallel to a major axis of iodine ions, but allows light having a polarization direction that is perpendicular to the major axis of the iodine ions. In other words, a polarization plate exhibiting light polarization is formed. Further, metal grating structure based polarization plates also find applications in liquid crystal displaying.

Generally, the TFT substrate and the CF substrate are each provided with a layer of polyimide (PI) made alignment film. The alignment film is set in direct contact with the liquid crystal to make the liquid crystal generating a predetermined tilt angle thereby providing liquid crystal molecules with a bearing angle. If no PI manufacturing process is involved, a conventional LCD product would lose alignment of the liquid crystal so as to lead to system response being slowed down and randomly tilting would happen. However, the PI manufacturing process must be conducted with high temperature baking (180-230°). Ordinary polarizers cannot take such a high temperature without causing any quality issue and thus, generally, an LCD panel that includes PI alignment films must involve externally mounted polarizers that are arranged outside the TFT substrate and the CF substrate. To resolve the above PI alignment film related issues, in the field of the art, a PI-free process has been proposed, in which a material having an alignment function is added, in the form of an additive, in currently used liquid crystal (by an amount of 0.1-5%) to form a self-aligning liquid crystal material. The additive can generally be of two types, one being ultraviolet (UV) light curable monomers, which, when irradiated with UV light, get polymerized on a substrate to form raised projections that achieve a purpose of mimicking PI alignment, and the other one being small molecules containing both strong polarity groups and liquid crystal ingredient groups, which are vertically lined up on an inorganic surface of a substrate by means of physical attachment or chemical reaction to thereby provide an effect of vertical alignment for replacing a PI alignment layer and thus achieving a purpose of vertical alignment.

Ultrathin displays are a market hot spot and it is an essential challenge of engineering to make the thickness of a display, such as a mobile phone and a television, even reduced.

### SUMMARY OF THE INVENTION

An object of the present invention is to provide a liquid crystal display (LCD) device that has an ultrathin LCD module structure that achieves optimized displaying.

To achieve the above object, the present invention provides an LCD device, which comprises a lower substrate and an upper substrate that are arranged opposite to each other, a liquid crystal layer interposed between the lower substrate and the upper substrate, and a side-edge backlight source disposed at one lateral side of the lower substrate;

wherein the liquid crystal layer comprises a self-aligning liquid crystal material that comprises a material having an alignment function;

the lower substrate comprises a first backing base plate, a first function layer disposed on one side of the first backing base plate that is adjacent to the liquid crystal layer, and a first polarization layer disposed on one side of the first backing base plate that is adjacent to the liquid crystal layer;

the upper substrate comprises a second backing base plate, a second function layer disposed on one side of the second backing base plate that is adjacent to the liquid crystal layer, and a second polarization layer disposed on one side of the second backing base plate that is distant from the liquid crystal layer; and

the first backing base plate functions as a light guide plate and the first backing base plate has a lateral side surface functioning as a light incident surface corresponding exactly to the side-edge backlight source.

The lower substrate is a color filter (CF) substrate and the upper substrate is a thin-film transistor (TFT) array substrate.

The lower substrate is a TFT array substrate and the upper substrate is CF substrate.

The second polarization layer is disposed between the second backing base plate and the second function layer.

The second polarization layer is disposed between the second function layer and the liquid crystal layer and the second polarization layer is provided, on one side thereof adjacent to the liquid crystal layer, with a buffer layer.

The first polarization layer is disposed between the first backing base plate and the first function layer.

The first polarization layer is disposed between the first function layer and the liquid crystal layer and the first polarization layer is provided, on one side thereof adjacent to the liquid crystal layer, with a buffer layer.

The first polarization layer and the second polarization layer are each an iodine series polarization layer, a dye series polarization layer, or a metal grating polarization layer.

The first backing base plate and the second backing base plate are glass plates.

The present invention also provides an LCD device, which comprises a lower substrate and an upper substrate that are arranged opposite to each other, a liquid crystal layer interposed between the lower substrate and the upper substrate, and a side-edge backlight source disposed at one lateral side of the lower substrate;

wherein the liquid crystal layer comprises a self-aligning liquid crystal material that comprises a material having an alignment function;

the lower substrate comprises a first backing base plate, a first function layer disposed on one side of the first backing base plate that is adjacent to the liquid crystal layer, and a first polarization layer disposed on one side of the first backing base plate that is adjacent to the liquid crystal layer;

the upper substrate comprises a second backing base plate, a second function layer disposed on one side of the second backing base plate that is adjacent to the liquid crystal layer, and a second polarization layer disposed on one side of the second backing base plate that is distant from the liquid crystal layer; and

the first backing base plate functions as a light guide plate and the first backing base plate has a lateral side surface functioning as a light incident surface corresponding exactly to the side-edge backlight source;

wherein the first polarization layer and the second polarization layer are each an iodine series polarization layer, a dye series polarization layer, or a metal grating polarization layer; and

wherein the first backing base plate and the second backing base plate are glass plates.

The efficacy of the present invention is that the present invention provides an LCD device, which comprises a lower substrate and an upper substrate that are opposite to one another, a liquid crystal layer interposed between the lower substrate and the upper substrate, and a side-edge backlight source disposed at one lateral side of the lower substrate. A PI-free manufacturing process is utilized with the liquid crystal layer comprising a self-aligning liquid crystal material such that no PI alignment film is provided on the upper and lower substrates. The polarization layer of the lower substrate is of an internally built arrangement with the backing base plate of the lower substrate serving as a light guide plate of a side-edge backlight source so that there is no need to further include an additional light guide plate and an ultrathin modular structure with optimized displaying performance is provided.

### BRIEF DESCRIPTION OF THE DRAWINGS

The technical solution, as well as other beneficial advantages, of the present invention will be apparent from the following detailed description of embodiments of the present invention, with reference to the attached drawing.

In the drawing:

FIG. 1 is a schematic view illustrating the structure of a liquid crystal display (LCD) device according to a first embodiment of the present invention;

FIG. 2 is a schematic view illustrating the structure of an LCD device according to a second embodiment of the present invention;

FIG. 3 is a schematic view illustrating the structure of an LCD device according to a third embodiment of the present invention; and

FIG. 4 is a schematic view illustrating the structure of an LCD device according to a fourth embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention with reference to the attached drawings.

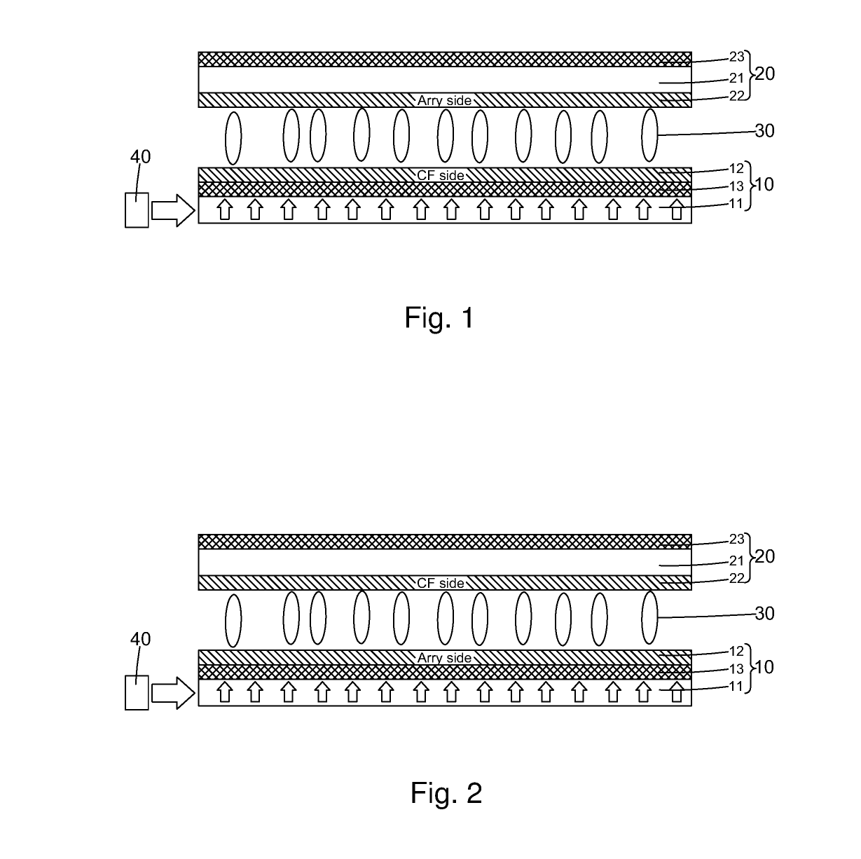

Referring to FIG. 1, which is a schematic view showing a liquid crystal display (LCD) device according to a first embodiment of the present invention, the LCD comprises a lower substrate 10 and an upper substrate 20 that are arranged opposite to each other, a liquid crystal layer 30 interposed between the lower substrate 10 and the upper substrate 20, and a side-edge backlight source 40 disposed at one lateral side of the lower substrate 10.

The liquid crystal layer 30 comprises a self-aligning liquid crystal material that comprises a material having an alignment function.

The lower substrate 10 comprises a first backing base plate 11, a first function layer 12 disposed on one side of the first backing base plate 11 that is adjacent to the liquid crystal layer 30, and a first polarization layer 13 disposed between the first backing base plate 11 and the first function layer 12.

The upper substrate 20 comprises a second backing base plate 21, a second function layer 22 disposed on one side of the second backing base plate 21 that is adjacent to the liquid crystal layer 30, and a second polarization layer 23 disposed on one side of the second backing base plate 21 that is distant from the liquid crystal layer 30.

The first backing base plate 11 functions as a light guide plate and the first backing base plate 11 has a lateral side surface functioning as a light incident surface corresponding exactly to the side-edge backlight source 40. Specifically, the lower substrate 10 is a color filter (CF) substrate and the upper substrate 20 is a thin-film transistor (TFT) array substrate. The first function layer 12 and the second function layer 22 are respectively a function layer (CF side) of the CF substrate, such as a CF layer, and a function layer (Arry side) of the TFT array substrate, such as a TFT array layer.

It is noted that the present invention involves a PI-free manufacturing process, where the liquid crystal layer 30 comprises a self-aligning material so that no PI alignment film is necessarily provided on the upper and lower substrates 20, 10. Therefore, the first polarization layer 13 can be of an internally built arrangement and there is no potential risk of being damaged by a high temperature of a PI manufacturing process, so that the first backing base plate 11 of the lower substrate 10 could serve as a light guide plate for the side-edge backlight source 40 and there is no need to further include an additional light guide plate thereby making the LCD device feature an ultrathin modular structure with optimized displaying performance.

Specifically, the material of the liquid crystal layer 30 having the alignment function comprises ultraviolet (UV) light curable monomers, which, when irradiated with UV light, get polymerized on the upper and lower substrates 20, 10 to form raised projections that achieve a purpose of alignment similar to PI, or alternatively, comprises small molecules containing both strong polarity groups and liquid crystal ingredient groups, which are vertically lined up on inorganic surfaces of the upper and lower substrates 20, 10 by means of physical attachment or chemical reaction to provide an effect of vertical alignment.

Specifically, the first polarization layer 13 and the second polarization layer 23 can each be an iodine series polarization layer, a dye series polarization layer, or a metal grating polarization layer. Since the present invention involves a liquid crystal layer 30 that is formed of a self-aligning liquid crystal material, no PI alignment film is provided on the upper and lower substrates 20, 10, so that even though the first polarization layer 13 and the second polarization layer 23 are iodine series polarization layers or dye series polarization layers that are organic materials, there is no potential risk of being damaged by high temperature baking (180-230° C.) conducted in a PI manufacturing process. Specifically, the first backing base plate 11 and the second backing base plate 21 are glass plates.

Referring to FIG. 2, which is a schematic view showing an LCD device according to a second embodiment of the present invention, compared with the above-described first embodiment, in the instant embodiment, the lower substrate 10 is a TFT array substrate, while the upper substrate 20 is a CF substrate. The first function layer 12 is a function layer of the TFT array substrate, and the second function layer 22 is a function layer of the CF substrate. The remaining is identical to the first embodiment and further details will not be repeated herein.

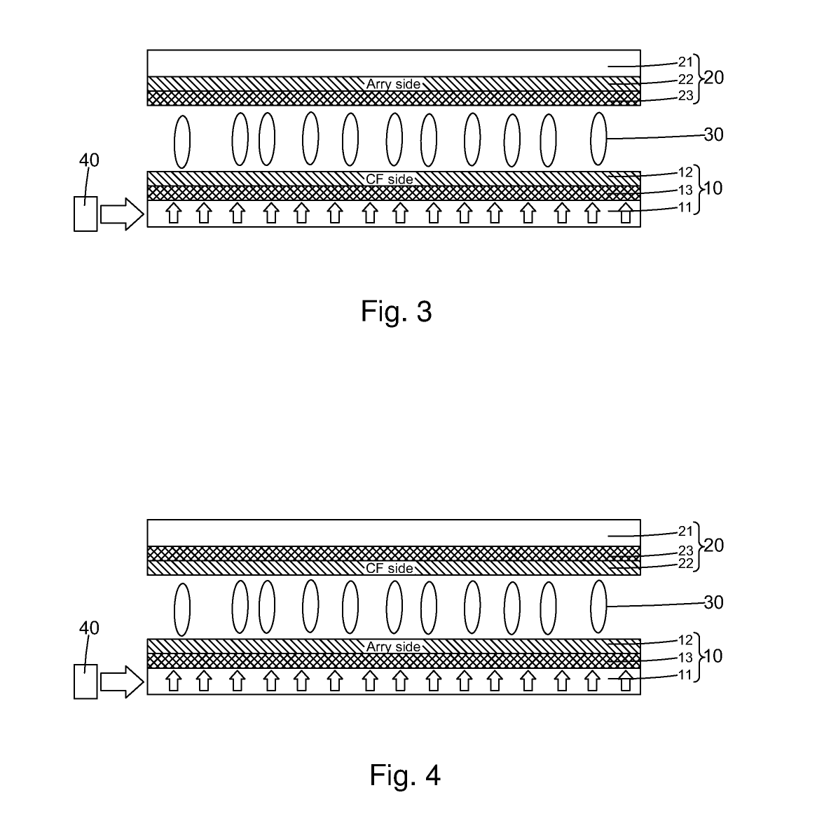

Referring to FIG. 3, which is a schematic view showing an LCD device according to a third embodiment of the present invention, compared with the above-described first embodiment, in the instant embodiment, the second polarization layer 23 is disposed between the second function layer 22 and the liquid crystal layer 30. To prevent the second polarization layer 23 from being damaged due to direct contact with the liquid crystal layer 30, a buffer layer (not shown) is provided on one side of the second polarization layer 23 that is adjacent to the liquid crystal layer 30. The remaining is identical to the first embodiment and further details will not be repeated herein.

Referring to FIG. 4, which is a schematic view showing an LCD device according to a fourth embodiment of the present invention, compared with the above-described first embodiment, in the instant embodiment, the lower substrate 10 is a TFT array substrate, while the upper substrate 20 is a CF substrate. The first function layer 12 is a function layer of the TFT array substrate, and the second function layer 22 is a function layer of the CF substrate. The second polarization layer 23 is disposed between the second backing base plate 21 and the second function layer 22. The remaining is identical to the first embodiment and further details will not be repeated herein.

It is noted here that in the present invention, the position where the first polarization layer 13 is disposed on the lower substrate 10 and the position where the second polarization layer 23 is disposed on the upper substrate 20 can be any desired arrangement of combination. The first polarization layer could be disposed between the first backing base plate 11 and the first function layer 12, or between the first function layer 12 and the liquid crystal layer 30. It is apparent that when the first function layer 12 comprises a structure having multiple function layers, the first polarization layer 13 could be disposed in the first function layer 12. When the first polarization layer 13 is disposed between the first function layer 12 and the liquid crystal layer 30, to protect the first polarization layer 13 from damage resulting from direct contact with the liquid crystal layer 30, a buffer layer may be provided on one side of the first polarization layer 13 that is adjacent to the liquid crystal layer 30. For the second polarization layer 23, it can be disposed on one side of the second backing base plate 21 that is distant from the liquid crystal layer 30, or between the second backing base plate 21 and the second function layer 22, or between the second function layer 22 and the liquid crystal layer 30. It is apparent that when the second function layer 22 comprises a structure having multiple function layers, the second polarization layer 23 could be disposed in the second function layer 22. When the second polarization layer 23 is disposed between the second function layer 22 and the liquid crystal layer 30, to protect the second polarization layer 23 from damage resulting from direct contact with the liquid crystal layer 30, a buffer layer may be provided on one side of second first polarization layer 23 that is adjacent to the liquid crystal layer 30.

In summary, the present invention provides an LCD device, which comprises a lower substrate and an upper substrate that are opposite to one another, a liquid crystal layer interposed between the lower substrate and the upper substrate, and a side-edge backlight source disposed at one lateral side of the lower substrate. A PI-free manufacturing process is utilized with the liquid crystal layer comprising a self-aligning liquid crystal material such that no PI alignment film is provided on the upper and lower substrates. The polarization layer of the lower substrate is of an internally built arrangement with the backing base plate of the lower substrate serving as a light guide plate of a side-edge backlight source so that there is no need to further include an additional light guide plate and an ultrathin modular structure with optimized displaying performance is provided.

Based on the description given above, those having ordinary skills of the art may easily contemplate various changes and modifications of the technical solution and technical ideas of the present invention and all these changes and modifications are considered within the protection scope of the present invention defined in the appended claims.

What is claimed is:

1. A liquid crystal display (LCD) device, comprising a lower substrate and an upper substrate that are arranged opposite to each other, a liquid crystal layer interposed between the lower substrate and the upper substrate, and a side-edge backlight source disposed at one lateral side of the lower substrate;
wherein the liquid crystal layer comprises a self-aligning liquid crystal material that comprises a material having an alignment function;
the lower substrate comprises a first backing base plate, a first function layer disposed on one side of the first backing base plate that is adjacent to the liquid crystal layer, and a first polarization layer disposed on one side of the first backing base plate that is adjacent to the liquid crystal layer;
the upper substrate comprises a second backing base plate, a second function layer disposed on one side of the second backing base plate that is adjacent to the liquid crystal layer, and a second polarization layer disposed on one side of the second backing base plate that is distant from the liquid crystal layer; and
the first backing base plate functions as a light guide plate and the first backing base plate has a lateral side surface functioning as a light incident surface corresponding exactly to the side-edge backlight source.

2. The LCD device as claimed in claim 1, wherein the lower substrate is a color filter (CF) substrate and the upper substrate is a thin-film transistor (TFT) array substrate.

3. The LCD device as claimed in claim 1, wherein the lower substrate is a TFT array substrate and the upper substrate is CF substrate.

4. The LCD device as claimed in claim 1, wherein the second polarization layer is disposed between the second backing base plate and the second function layer.

5. The LCD device as claimed in claim 1, wherein the second polarization layer is disposed between the second function layer and the liquid crystal layer and the second polarization layer is provided, on one side thereof adjacent to the liquid crystal layer, with a buffer layer.

6. The LCD device as claimed in claim 1, wherein the first polarization layer is disposed between the first backing base plate and the first function layer.

7. The LCD device as claimed in claim 1, wherein the first polarization layer is disposed between the first function layer and the liquid crystal layer and the first polarization layer is provided, on one side thereof adjacent to the liquid crystal layer, with a buffer layer.

8. The LCD device as claimed in claim 1, wherein the first polarization layer and the second polarization layer are each an iodine series polarization layer, a dye series polarization layer, or a metal grating polarization layer.

9. The LCD device as claimed in claim 1, wherein the first backing base plate and the second backing base plate are glass plates.

10. A liquid crystal display (LCD) device, comprising a lower substrate and an upper substrate that are arranged opposite to each other, a liquid crystal layer interposed between the lower substrate and the upper substrate, and a side-edge backlight source disposed at one lateral side of the lower substrate;
wherein the liquid crystal layer comprises a self-aligning liquid crystal material that comprises a material having an alignment function;
the lower substrate comprises a first backing base plate, a first function layer disposed on one side of the first backing base plate that is adjacent to the liquid crystal layer, and a first polarization layer disposed on one side of the first backing base plate that is adjacent to the liquid crystal layer;
the upper substrate comprises a second backing base plate, a second function layer disposed on one side of the second backing base plate that is adjacent to the liquid crystal layer, and a second polarization layer disposed on one side of the second backing base plate that is distant from the liquid crystal layer; and
the first backing base plate functions as a light guide plate and the first backing base plate has a lateral side surface functioning as a light incident surface corresponding exactly to the side-edge backlight source;
wherein the first polarization layer and the second polarization layer are each an iodine series polarization layer, a dye series polarization layer, or a metal grating polarization layer; and
wherein the first backing base plate and the second backing base plate are glass plates.

11. The LCD device as claimed in claim 10, wherein the lower substrate is a color filter (CF) substrate and the upper substrate is a thin-film transistor (TFT) array substrate.

12. The LCD device as claimed in claim 10, wherein the lower substrate is a TFT array substrate and the upper substrate is CF substrate.

13. The LCD device as claimed in claim 10, wherein the second polarization layer is disposed between the second backing base plate and the second function layer.

14. The LCD device as claimed in claim 10, wherein the second polarization layer is disposed between the second function layer and the liquid crystal layer and the second polarization layer is provided, on one side thereof adjacent to the liquid crystal layer, with a buffer layer.

15. The LCD device as claimed in claim 10, wherein the first polarization layer is disposed between the first backing base plate and the first function layer.

16. The LCD device as claimed in claim 10, wherein the first polarization layer is disposed between the first function layer and the liquid crystal layer and the first polarization layer is provided, on one side thereof adjacent to the liquid crystal layer, with a buffer layer.
